(19) United States
(12) Patent Application Publication
(10) Pub. No.: US 2008/0309044 A1
(43) Pub. Date: Dec. 18, 2008

(54) VEHICLE SUSPENSION ARM FITTING STRUCTURE

(75) Inventor: Akeru NAKAMURA, Toyota-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: TOYOTA JIDOSHA KABUSHIKI KAISHA, Toyota-shi (JP)

(21) Appl. No.: 12/132,873

(22) Filed: Jun. 4, 2008

(30) Foreign Application Priority Data
Jun. 13, 2007 (JP) 2007-156175

(51) Int. Cl. B60G 21/055

(52) U.S. Cl. 280/124.128

(57) ABSTRACT

A front end portion of a trailing arm is removably fitted to a vehicle body through a cylindrical bush. A bracket, which holds the bush to fit the front end portion to the vehicle body, includes: a holding portion that holds the bush; right/left first flange portions provided below the holding portion at positions on right/left sides of the holding portion, wherein the first flange portions contact lower surfaces of the respective horizontal wall portions, and the first flange portions are removably fixed to the respective horizontal wall portions using first fastening portions; and right/left second flange portions provided behind the holding portion at positions on right/left sides of the holding portion, wherein the second flange portions contact rear surfaces of the respective upright wall portions, and the second flange portions are removably fixed to the respective upright wall portions using second fastening portions.

### INCORPORATION BY REFERENCE

This document claims priority to Japanese Patent Application No. 2007-156175, filed on Jun. 13, 2007, the entire content of which are hereby incorporated by reference.

### BACKGROUND OF THE INVENTION

1. Field of the Invention

The invention relates to a vehicle suspension arm fitting structure. More specifically, the invention relates to a vehicle suspension arm fitting structure in which a front end portion of a trailing arm of a vehicle rear suspension system is removably fitted to a vehicle body through a cylindrical bush.

2. Description of the Related Art

Japanese Patent Application Publication No. 5-286321 (JP-A-5-286321) describes an example of a vehicle suspension arm fitting structure. In that vehicle suspension arm fitting structure, a bracket holds a bush to fit a front end portion of a trailing arm to the vehicle body, and the bracket includes a cylindrical holding portion and a pair of right and left flange portions. The cylindrical holding portion holds the bush. The right and left flange portions are provided on right and left sides of the holding portion, and removably fixed to the vehicle body using a bolt/nut fastening.

In the vehicle suspension arm fitting structure described in Japanese Patent Application Publication No. 5-286321 (JP-A-5-286321), bolt insertion holes are formed in the right and left flange portions to extend in a height direction of the vehicle, and bolts are inserted through the bolt insertion holes to fix the flange portions to the vehicle body. Accordingly, the axes of the bolts extend in the height direction of the vehicle (i.e., the vertical direction of the vehicle). Thus, when a main acting force (i.e., a force in the longitudinal direction of the vehicle) is applied from the trailing arm to the vehicle body, the force acts in a direction in which the bolts slide (i.e., the longitudinal direction of the vehicle). As a result, the bolts tend to be loosened.

### SUMMARY OF THE INVENTION

A first aspect of the invention relates to a vehicle suspension arm fitting structure. The vehicle suspension arm fitting structure includes: a trailing arm provided in a rear suspension system of a vehicle, wherein a front end portion of the trailing arm is removably fitted to a vehicle body of the vehicle; a framework structure provided in the vehicle body of the vehicle, wherein the framework structure is provided with a pair of right and left horizontal wall portions and a pair of right and left upright wall portions; a cylindrical bush to which the front end portion of the trailing arm is fitted; and a bracket. The bracket includes: a holding portion that holds the bush; a pair of right and left first flange portions provided below the holding portion in a height direction of the vehicle at positions on right and left sides of the holding portion, wherein the first flange portions contact lower surfaces of the respective horizontal wall portions in the height direction of the vehicle, and the first flange portions are removably fixed to the respective horizontal wall portions using first fastening portions; and a pair of right and left second flange portions provided behind the holding portion in a longitudinal direction of the vehicle at positions on right and left sides of the holding portion, wherein the second flange portions contact rear surfaces of the respective upright wall portions in the longitudinal direction of the vehicle, and the second flange portions are removably fixed to the respective upright wall portions using second fastening portions.

In the vehicle suspension arm fitting structure according to the first aspect, the front end portion of the trailing arm is fitted to the holding portion of the bracket through the bush. The framework structure of the vehicle body is provided with the pair of right and left horizontal wall portions and the pair of right and left upright wall portions. The bracket includes the pair of right and left first flange portions and the pair of right and left second flange portions. The first flange portions of the bracket contact the lower surfaces of the respective horizontal wall portions in the height direction of the vehicle, and the first flange portions are fixed to the respective horizontal wall portions using the first fastening portions. In addition, the second flange portions of the bracket contact the rear surfaces of the respective upright wall portions in the longitudinal direction of the vehicle, and the second flange portions are fixed to the respective upright wall portions using the second fastening portions. Thus, it is possible to fit the front end portion of the trailing arm to the vehicle body. Also, it is possible to remove the front end portion of the trailing arm from the vehicle body, by loosening each fastening portion. Thus, the trailing arm is easily fitted to and removed from the vehicle body.

When the front end portion of the trailing arm is fitted to the vehicle body, a main acting force applied from the trailing arm to the vehicle body (i.e., a force in the longitudinal direction of the vehicle) is divided into acting forces transmitted from the first flange portions of the bracket to the respective horizontal wall portions with which the framework structure is provided (i.e., acting forces that tend to loosen the fastening portions in the horizontal wall portions), and acting forces transmitted from the second flange portions of the bracket to the respective upright wall portions with which the framework structure is provided (i.e., acting forces that are unlikely to loosen the fastening portions in the upright wall portions). Therefore, it is possible to reduce the possibility that each fastening portion is loosened, as compared to the case in which the main acting force from the trailing arm is applied only to the horizontal wall portions with which the framework structure is provided (i.e., the case in which the framework structure is not provided with the upright wall portions). This increases joint strength between the portions fastened to each other by the fastening portions. In addition, a large bending moment is unlikely to be applied to the horizontal wall portions with which the framework structure is provided. Thus, the strength of the vehicle body and framework structure is increased. As a result, it is possible to reduce the thickness of a plate material that constitutes the vehicle body, thereby reducing the weight of the vehicle body.

As should be apparent, the invention can provide a number of advantageous features and benefits. It is to be understood that, in practicing the invention, an embodiment can be constructed to include one or more features or benefits of embodiments disclosed herein, but not others. Accordingly, it is to be understood that the preferred embodiments discussed herein are provided as examples and are not to be construed as limiting, particularly since embodiments can be formed to practice the invention that do not include each of the features of the disclosed examples.

### BRIEF DESCRIPTION OF THE DRAWINGS

The foregoing and further objects, features and advantages of the invention will become apparent from the following description of example embodiments with reference to the accompanying drawings, wherein like numerals are used to represent like elements and wherein:

FIG. 1 is a plan view schematically showing a first embodiment of the invention;

FIG. 2 is a cross sectional view taken along line 2-2 in FIG. 1;

FIG. 3 is an exploded perspective view showing a trailing arm, a bush, a suspension bracket, right and left vehicle brackets, and other components;

FIG. 4 is an exploded perspective view showing a second embodiment of the invention in which a rocker and a side member, which are included in a framework structure of a vehicle body, are provided integrally with the right and left vehicle brackets; and

FIG. 5 is an exploded perspective view showing a third embodiment of the invention in which a holding portion of the suspension bracket has a flat shape, and therefore, the suspension bracket can be press-formed.

### DETAILED DESCRIPTION OF EMBODIMENTS

Referring now to the drawings, like reference numerals are utilized to designate identical or corresponding parts throughout the several views.

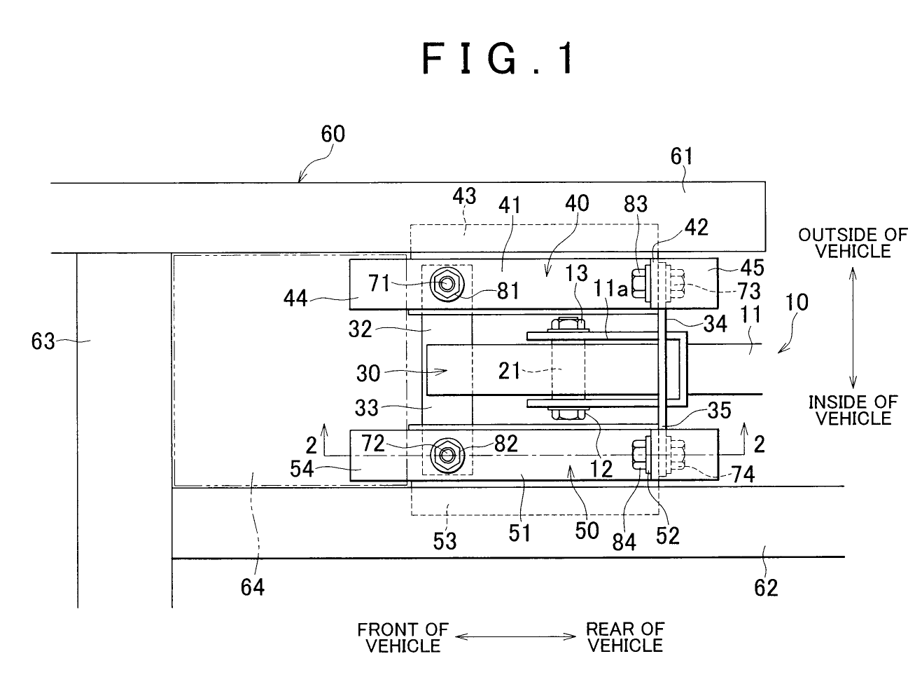

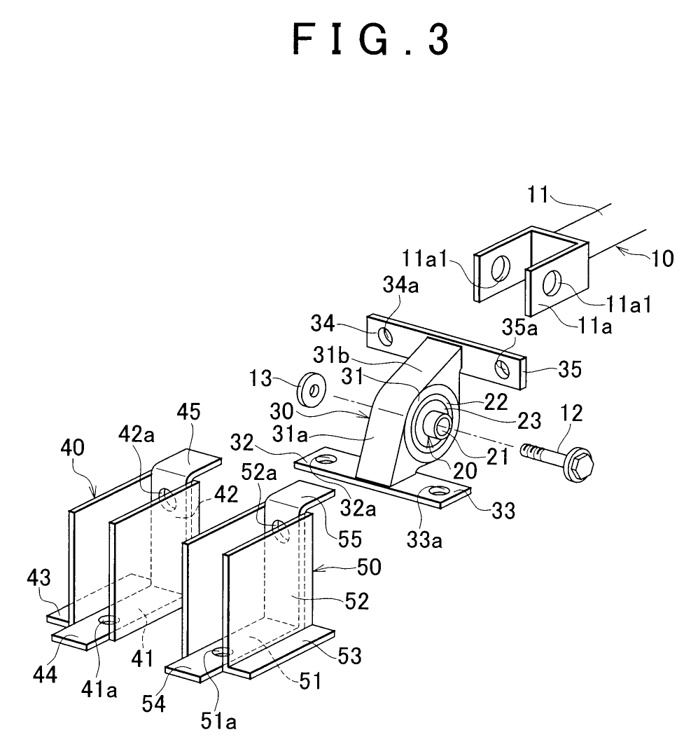

Hereinafter, a first embodiment of the invention will be described with reference to the drawings. Each of FIG. 1 to FIG. 3 shows a rear suspension system 10 of a vehicle, to which the invention can be applied. The rear suspension system 10 includes a trailing arm 11. A front end portion 11a of the trailing arm 11 is removably fitted to a vehicle body 60 through a cylindrical bush 20, a suspension bracket 30, and vehicle body brackets 40 and 50. The front end portion 11a of the trailing arm 11 has a yoke shape. Insertion holes 11a1, 11a1 are formed in the front end portion 11a (refer to FIG. 3). A washer-faced bolt 12 is inserted through the insertion holes 11a1, 11a1.

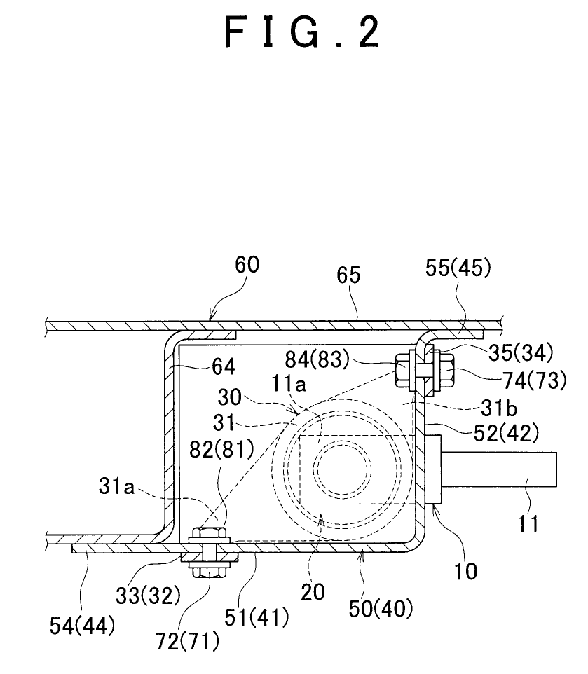

The bush 20 includes a cylindrical inner collar 21, for example made of metal, a cylindrical outer collar 22, for example made of metal, and a cylindrical rubber member 23 provided between the inner collar 21 and the outer collar 22. The outer peripheral portion of the bush 20, that is, the outer collar 22, is press-fitted into a cylindrical holding portion 31 of the suspension bracket 30 (refer to FIG. 2 and FIG. 3). The inner peripheral portion of the bush 20, that is, the inner collar 21, is fitted to the front end portion 11a of the trailing arm 11 using the washer-faced bolt 12 and a washer-faced nut 13 (refer to FIG. 1). In FIG. 2, the bolt 12 and the nut 13 are omitted.

The suspension bracket 30, for example made of metal, holds the bush 20 to fit the front end portion 11a of the trailing arm 11 to the vehicle body 60 through the vehicle body brackets 40 and 50. The suspension bracket 30 includes the cylindrical holding portion 31 that holds the bush 20, a pair of right and left lower first flange portions 32 and 33, and a pair of right and left rear second flange portions 34 and 35. The lower flange portions 32 and 33 are provided below the holding portion 31 in the height direction of the vehicle at positions on right and left sides of the holding portion 31. The lower flange portions 32 and 33 are fixed, for example by welding, to a lower surface of a front end of an arm portion 31a that extends from the holding portion 31. The rear flange portions 34 and 35 are provided behind the holding portion 31 in the longitudinal direction of the vehicle at positions on right and left sides of the holding portion 31. The rear flange portions 34 and 35 are fixed, for example by welding, to a rear surface of a rear end of an arm portion 31b that extends from the holding portion 31.

The lower flange portions 32 and 33, which are placed in a horizontal position, extend in the width direction of the vehicle. Bolt insertion holes 32a and 33a are formed in the lower flange portions 32 and 33, respectively, to extend in the height direction of the vehicle (vertical direction). Washer-faced bolts 71 and 72 are inserted through the bolt insertion holes 32a and 33a, respectively. The rear flange portions 34 and 35, which are placed in an upright position, extend in the width direction of the vehicle. Bolt insertion holes 34a and 35a are formed in the rear flange portions 34 and 35, respectively, to extend in the longitudinal direction of the vehicle (horizontal direction). Washer-faced bolts 73 and 74 are inserted through the bolt insertion holes 34a and 35a, respectively.

The vehicle body bracket 40, for example made of metal, includes a horizontal wall portion 41, an upright wall portion 42, a side flange portion 43, a front flange portion 44, and a rear flange portion 45. The vehicle body bracket 40 can be fixed to the vehicle body 60, for example by welding, before the front end portion 11a of the trailing arm 11 is fitted to the vehicle body 60 through the bush 20 and the suspension bracket 30.

The horizontal wall portion 41, which is placed in a horizontal position, extends in the longitudinal direction of the vehicle. A bolt insertion hole 41a is formed in the horizontal wall portion 41 to extend in the height direction of the vehicle (vertical direction). The bolt 71 is also inserted through the bolt insertion hole 41a. The upright wall portion 42, which is placed in an upright position, extends in the height direction of the vehicle. A bolt insertion hole 42a is formed in the upright wall portion 42 to extend in the longitudinal direction of the vehicle (horizontal direction). The bolt 73 is also inserted through the bolt insertion hole 42a.

The side flange portion 43 is fixed, for example by welding, to a lower surface of a rocker 61 that is included in a framework structure of the vehicle body 60. The front flange portion 44 is fixed, for example by welding, to a lower surface of an auxiliary bracket 64 of the vehicle body 60. The rear flange portion 45 is fixed, for example by welding, to a lower surface of a floor 65 (refer to FIG. 2) of the vehicle body 60.

The vehicle body bracket 50, for example made of metal, includes a horizontal wall portion 51, an upright wall portion 52, a side flange portion 53, a front flange portion 54, and a rear flange portion 55. The vehicle body bracket 50 can be fixed to the vehicle body 60, for example by welding, before the front end portion 11a of the trailing arm 11 is fitted to the vehicle body 60 through the bush 20 and the suspension bracket 30.

The horizontal wall portion 51, which is placed in a horizontal position, extends in the longitudinal direction of the vehicle. A bolt insertion hole 51a is formed in the horizontal wall portion 51 to extend in the height direction of the vehicle (vertical direction). The bolt 72 is also inserted through the bolt insertion hole 51a. The upright wall portion 52, which is placed in an upright position, extends in the height direction of the vehicle. A bolt insertion hole 52a is formed in the upright wall portion 52 to extend in the longitudinal direction of the vehicle (horizontal direction). The bolt 74 is also inserted through the bolt insertion hole 52a.

The side flange portion 53 is fixed, for example by welding, to a lower surface of a side member 62 that is included in the framework structure of the vehicle body 60. The front flange portion 54 is fixed, for example by welding, to the lower surface of the auxiliary bracket 64 of the vehicle body 60. The rear flange portion 55 is fixed, for example by welding, to the lower surface of the floor 65 of the vehicle body 60.

The vehicle body 60 includes the framework structure, for example made of metal. The framework structure for example includes the rocker 61 provided in a side portion of the vehicle to extend in the longitudinal direction of the vehicle, the side member 62 provided inside of the rocker 61 in the width direction of the vehicle to extend in the longitudinal direction of the vehicle, and a cross member 63 that extends in the width direction of the vehicle, and that integrally connects the rocker 61 to the side member 62. The rocker 61 may be regarded as a first member. The side member 62 may be regarded as a second member. The cross member 63 may be regarded as a third member. The vehicle body 60 further includes the auxiliary bracket 64, for example made of metal, and the floor 65, for example made of metal. The auxiliary bracket 64 is fixed to one or all of the framework members, for example by welding. The floor 65 is fixed on or above the framework members and the auxiliary bracket 64.

In the embodiment, the vehicle body brackets 40 and 50 are fixed to the constituent members of the vehicle body 60 in advance. The right and left lower flange portions 32 and 33 of the suspension bracket 30 contact lower surfaces of the respective right and left horizontal wall portions 41 and 51 of the vehicle body brackets 40 and 50 in the height direction of the vehicle. The lower flange portions 32 and 33 are removably fixed to the respective horizontal wall portions 41 and 51 using the bolts 71 and 72 and the nuts 81 and 82 that function as a fastening portion. The nuts 81 and 82 are fixed in advance to upper surfaces of the respective horizontal wall portions 41 and 51, for example by welding.

Also, in the embodiment, the right and left rear flange portions 34 and 35 of the suspension bracket 30 contact rear surfaces of the respective right and left upright wall portions 42 and 52 of the vehicle body brackets 40 and 50 in the longitudinal direction of the vehicle. The rear flange portions 34 and 35 are removably fixed to the respective upright wall portions 42 and 52 using the bolts 73 and 74 and the nuts 83 and 84 that function as a fastening portion. The nuts 83 and 84 are fixed in advance to front surfaces of the respective upright wall portions 42 and 52, for example by welding.

In the above-described embodiment, the front end portion 11a of the trailing arm 11 is fitted to the holding portion 31 of the suspension bracket 30 using the bolt 12 (not shown in FIG. 2), the nut 13 (not shown in FIG. 2), and the bush 20. The right and left lower flange portions 32 and 33 of the suspension bracket 30 contact the lower surfaces of the respective right and left horizontal wall portions 41 and 51 of the vehicle body brackets 40 and 50 in the height direction of the vehicle, and the lower flange portions 32 and 33 are fixed to the respective horizontal wall portions 41 and 51 using the bolts 71 and 72 and the nuts 81 and 82 that function as fastening portions. In addition, the right and left rear flange portions 34 and 35 of the suspension bracket 30 contact the rear surfaces of the respective right and left upright wall portions 42 and 52 of the vehicle body brackets 40 and 50 in the longitudinal direction of the vehicle, and the rear flange portions 34 and 35 are fixed to the respective upright wall portions 42 and 52 using the bolts 73 and 74 and the nuts 83 and 84 that function as fastening portions. Thus, it is possible to fit the front end portion 11a of the trailing arm 11 to the vehicle body 60. Also, it is possible to remove the front end portion 11a of the trailing arm 11 from the vehicle body 60, by loosening the fastening portions. Thus, the trailing arm 11 is easily fitted to and removed from the vehicle body 60.

When the front end portion 11a of the trailing arm 11 is fitted to the vehicle body 60, a main acting force applied from the trailing arm 11 to the vehicle body 60 (i.e., a force in the longitudinal direction of the vehicle) is divided into acting forces transmitted from the lower flange portions 32 and 33 of the suspension bracket 30 to the respective horizontal wall portions 41 and 51 of the vehicle body brackets 40 and 50 (i.e., acting forces that tend to loosen the fastening portions of nuts/bolts in the horizontal wall portions 41 and 51), and acting forces transmitted from the rear flange portions 34 and 35 of the suspension bracket 30 to the respective upright wall portions 42 and 52 of the vehicle body brackets 40 and 50 (i.e., acting forces that are unlikely to loosen the fastening portions of nuts/bolts in the upright wall portions 42 and 52).

Therefore, it is possible to reduce the possibility that each fastening portions of nuts/bolts is loosened, as compared to the case in which the main acting force from the trailing arm 11 is applied only to the horizontal wall portions with which the framework structure of the vehicle body 60 is provided (i.e., compared to the case in which the upright wall portions 42 and 52 are not provided in the vehicle body brackets 40 and 50). This increases joint strength between the portions fastened to each other by the fastening portions. In addition, a large bending moment is unlikely to be applied to each of the horizontal wall portions 41 and 51 of the vehicle body brackets 40 and 50. Thus, the strength of the vehicle body and framework structure is increased. As a result, it is possible to reduce the thickness of a plate material that constitutes the vehicle body 60 (including a plate material that constitutes the vehicle body brackets 40 and 50), thereby reducing the weight of the vehicle body 60 (including the vehicle body brackets 40 and 50).

In the first embodiment, the framework structure of the vehicle body 60 includes the rocker 61 provided in the side portion of the vehicle to extend in the longitudinal direction of the vehicle, the side member 62 provided inside of the rocker 61 in the width direction of the vehicle to extend in the longitudinal direction of the vehicle, and a cross member 63 that extends in the width direction of the vehicle, and that integrally connects the rocker 61 to the side member 62. The horizontal wall portion 41 and the upright wall portion 42 are provided in the vehicle body bracket 40 fixed to the rocker 61. The horizontal wall portion 51 and the upright wall portion 52 are provided in the vehicle body bracket 50 fixed to the side member 62. The cross member 63 connects the rocker 61 to the side member 62 at a position ahead of the vehicle body brackets 40 and 50 in the longitudinal direction of the vehicle.

Therefore, the suspension bracket 30, which holds the bush 20 to fit the front end portion 11a of the trailing arm 11 to the vehicle body 60, is housed in a space formed between the rocker 61 and the side member 62. As a result, the front end portion 11a of the trailing arm 11 is disposed at the highest possible position in the height direction of the vehicle. This improves the riding comfort of the vehicle. Also, a closed structure is formed between the rocker 61 and the side member 62, by the rocker 61 and the side member 62 that are connected to each other by the cross member 63, and the suspension bracket 30 and the vehicle body brackets 40 and 50 that are fixed to the rocker 61 and the side member 62. This increases coupling rigidity between the rocker 61 and the side member 62.

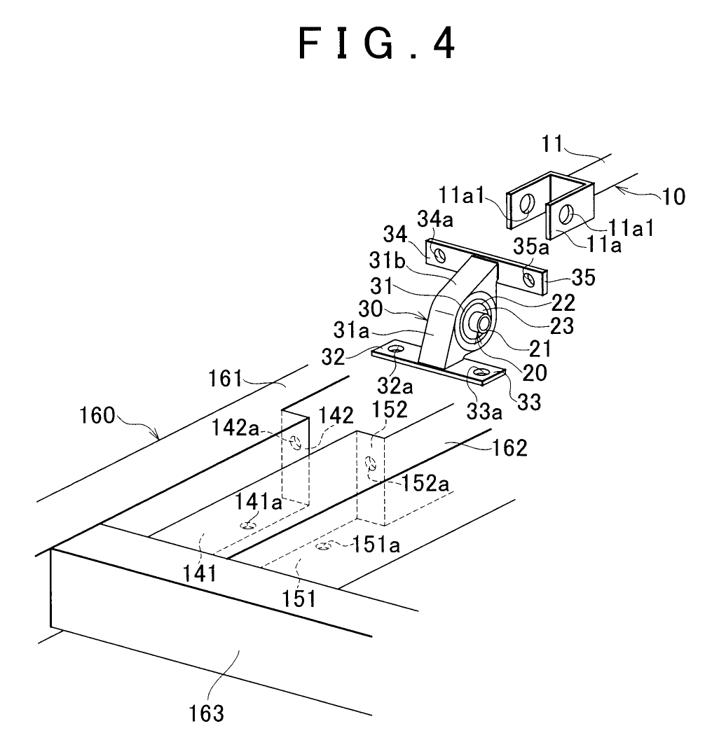

In the above-described first embodiment, the horizontal wall portions 41 and 51 and the upright wall portions 42 and 52 are provided in the vehicle body brackets 40 and 50 that are fixed to the constituent members of the vehicle body 60. However, as in a second embodiment shown in FIG. 4, a rocker 161, which is included in a framework structure of a vehicle body 160, may be provided integrally with a horizontal wall portion 141 and an upright wall portion 142, and a side member 162, which is also included in the framework structure of the vehicle body 160, may be provided integrally with a horizontal wall portion 151 and an upright wall portion 152.

As shown in FIG. 4, bolt insertion holes 141a and 151a are formed in the horizontal wall portions 141 and 151, respectively, and bolt insertion holes 142a and 152a are formed in the upright wall portions 142 and 152, respectively. Nuts (not shown) are fixed, for example by welding, to the horizontal wall portions 141 and 151 and the upright wall portions 142 and 152 at positions around the bolt insertion holes 141a, 151a, 142a, and 152a. The configuration of the second embodiment is substantially the same as the configuration of the first embodiment, except that a cross member 163 connects the rocker 161 to the side member 162, and an auxiliary bracket equivalent to the auxiliary bracket 64 in the first embodiment is omitted in the second embodiment. Thus, it is possible to obtain the same advantageous effects as those obtained in the first embodiment.

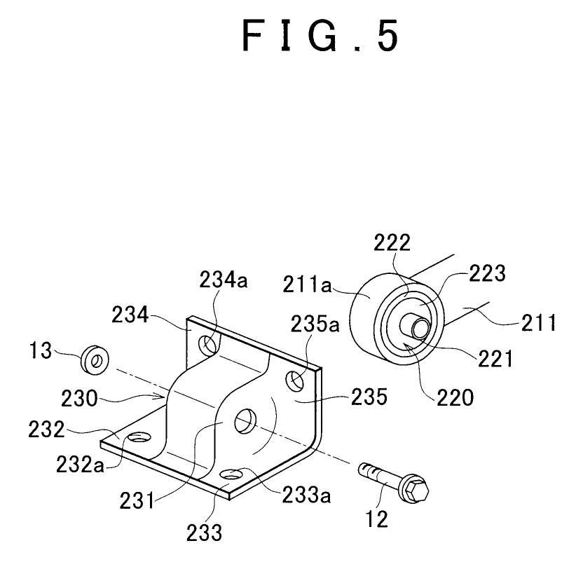

In each of the first and second embodiments, the holding portion 31 of the suspension bracket 30 has a cylindrical shape, and the outer peripheral portion of the bush 20, that is, the outer collar 22, is fitted to the holding portion 31. The inner peripheral portion of the bush 20, that is, the inner collar 21, is fitted to the front end portion 11a of the trailing arm 11. However, as in a third embodiment shown in FIG. 5, a front end portion 211a of a trailing arm 211 may have a cylindrical shape, and an outer peripheral portion of a bush 220, that is, an outer collar 222, may be fitted to the front end portion 211a; and a holding portion 231 of a suspension bracket 230 may have a flat shape, and an inner peripheral portion of the bush 220, that is, an inner collar 221, may be fitted to the holding portion 231.

The bush 220 in the third embodiment shown in FIG. 5 includes the cylindrical inner collar 221, the cylindrical outer collar 222, and a cylindrical rubber member 223. The suspension bracket 230 includes the holding portion 231, a pair of right and left lower flange portions 232 and 233 provided below the holding portion 231 in the height direction of the vehicle at positions on right and left sides of the holding portion 231, and a pair of right and left rear flange portions 234 and 235 provided behind the holding portion 231 in the longitudinal direction of the vehicle at positions on right and left sides of the holding portion 231. Bolt insertion holes 232a, 233a, 234a, and 235a are formed in the flange portions 232, 233, 234, and 235, respectively.

In the third embodiment shown in FIG. 5, the holding portion 231 of the suspension bracket 230 has a flat shape, and therefore, the suspension bracket 230 can be press-formed. This reduces cost. Also, welding is not necessary when the suspension bracket 230 is produced. This increases accuracy of the component.

In each of the embodiments, after the nuts, which are part of nut/bolt fastening portions, contact the horizontal wall portions and the upright wall portions at positions around the bolt insertion holes, the nuts are fixed, for example by welding, to the horizontal wall portions and the upright wall portions. Also, after the bolts, which are the other parts of the nut/bolt fastening portions, are inserted through the bolt insertion holes formed in the horizontal wall portions and the upright wall portions, the bolts may be fixed, for example by welding, to the horizontal wall portions and the upright wall portions.

Obviously, numerous other modifications and variations of the present invention are possible in light of the above teachings. It is therefore to be understood that within the scope of the appended claims, the invention may be practiced otherwise than as specifically described herein.

What is claimed is:

1. A vehicle suspension arm fitting structure comprising:
a trailing arm of a rear suspension system of a vehicle, wherein a front end portion of the trailing arm is removably fitted to a vehicle body of the vehicle;
a framework structure provided in the vehicle body of the vehicle, wherein the framework structure is provided with a pair of right and left horizontal wall portions and a pair of right and left upright wall portions;
a cylindrical bush to which the front end portion of the trailing arm is fitted; and
a bracket including:
a holding portion that holds the bush;
a pair of right and left first flange portions provided below the holding portion in a height direction of the vehicle at positions on right and left sides of the holding portion, wherein the first flange portions contact lower surfaces of the respective horizontal wall portions in the height direction of the vehicle, and the first flange portions are removably fixed to the respective horizontal wall portions using first fastening portions; and
a pair of right and left second flange portions provided behind the holding portion in a longitudinal direction of the vehicle at positions on right and left sides of the holding portion, wherein the second flange portions contact rear surfaces of the respective upright wall portions in the longitudinal direction of the vehicle, and the second flange portions are removably fixed to the respective upright wall portions using second fastening portions.

2. The vehicle suspension arm fitting structure according to claim 1, wherein:
the framework structure includes a first member provided in a side portion of the vehicle to extend in the longitudinal direction of the vehicle, a second member provided inside of the first member in a width direction of the vehicle to extend in the longitudinal direction of the vehicle, and a third member that extends in the width direction of the vehicle, and that integrally connects the first member to the second member;
the first member connects to one of the horizontal wall portions and one of the upright wall portions, and the second member connects to the other of the horizontal wall portions and the other of the upright wall portions; and
the third member connects the first member to the second member at a position ahead of the horizontal wall portions and the upright wall portions in the longitudinal direction of the vehicle.

3. The vehicle suspension arm fitting structure according to claim 1, wherein the bracket is housed in a space formed between the first member and the second member.

4. The vehicle suspension arm fitting structure according to claim 1, wherein one of the horizontal wall portions and one of the upright wall portions are provided in a first vehicle body bracket fixed to the framework structure, and the other of the horizontal wall portions and the other of the upright wall portions are provided in a second vehicle body bracket fixed to the framework structure.

5. The vehicle suspension arm fitting structure according to claim 1, wherein the framework structure is provided integrally with the horizontal wall portions and the upright wall portions.

6. The vehicle suspension arm fitting structure according to claim 1, wherein:
the holding portion of the bracket has a cylindrical shape, and an outer peripheral portion of the bush is fitted to the holding portion; and
an inner peripheral portion of the bush is fitted to the front end portion of the trailing arm.

7. The vehicle suspension arm fitting structure according to claim 1, wherein:
the front end portion of the trailing arm has a cylindrical shape, and an outer peripheral portion of the bush is fitted to the front end portion; and
the holding portion of the bracket has a flat shape, and an inner peripheral portion of the bush is fitted to the holding portion.

8. The vehicle suspension arm fitting structure according to claim 1, wherein the first and second fastening portions each include a nut and bolt.

9. The vehicle suspension arm fitting structure according to claim 1, wherein the framework structure further includes an auxiliary bracket between the first and second members.

10. The vehicle suspension arm fitting structure according to claim 1, wherein the first fastening portions are welded to the respective horizontal wall portions, and the second fastening portions are welded to the respective upright wall portions.

11. The vehicle suspension arm fitting structure according to claim 1, wherein the front end of the trailing arm is yoked.

12. The vehicle suspension arm fitting structure according to claim 1, wherein the bush includes a cylindrical inner metal collar, a cylindrical outer metal collar, and a rubber member between the cylindrical inner and outer collars.

13. The vehicle suspension arm fitting structure according to claim 5, wherein the first and second fastening portions each include a nut and bolt.

14. The vehicle suspension arm fitting structure according to claim 5, wherein the first fastening portions are welded to the respective horizontal wall portions, and the second fastening portions are welded to the respective upright wall portions.

15. The vehicle suspension arm fitting structure according to claim 5, wherein the front end of the trailing arm is yoked.

16. The vehicle suspension arm fitting structure according to claim 5, wherein the bush includes a cylindrical inner metal collar, a cylindrical outer metal collar, and a rubber member between the cylindrical inner and outer collars.

17. The vehicle suspension arm fitting structure according to claim 7, wherein the first and second fastening portions each include a nut and bolt.

18. The vehicle suspension arm fitting structure according to claim 7, wherein the first fastening portions are welded to the respective horizontal wall portions, and the second fastening portions are welded to the respective upright wall portions.

19. A vehicle suspension arm fitting structure comprising:
a trailing arm of a rear suspension system of a vehicle, wherein a front end portion of the trailing arm is removably fitted to a vehicle body of the vehicle;
a framework structure provided in the vehicle body of the vehicle, wherein the framework structure is provided with a pair of right and left horizontal wall portions and a pair of right and left upright wall portions;
fitting means to which the front end portion of the trailing arm is fitted; and
a bracket including:
means for holding the fitting means;
first means provided below the means for holding in a height direction of the vehicle at positions on right and left sides of the means for holding, for contacting lower surfaces of the respective horizontal wall portions in the height direction of the vehicle, and being removably fixed to the respective horizontal wall portions using first fastening means; and
second means provided behind the means for holding in a longitudinal direction of the vehicle at positions on right and left sides of the means for holding, for contacting rear surfaces of the respective upright wall portions in the longitudinal direction of the vehicle, and being removably fixed to the respective upright wall portions using second fastening means.
